(19) United States
(12) Patent Application Publication
(10) Pub. No.: US 2024/0374992 A1
(43) Pub. Date: Nov. 14, 2024

(54) INPUT DEVICE

(71) Applicant: SONY INTERACTIVE ENTERTAINMENT INC., Tokyo (JP)

(72) Inventors: Arthur Kwun, San Mateo, CA (US); Kenji Sasaki, Chiba (JP)

(21) Appl. No.: 18/652,769

(22) Filed: May 1, 2024

Related U.S. Application Data
(60) Provisional application No. 63/465,256, filed on May 10, 2023.

(51) Int. Cl. A63F 13/22; A63F 13/24

(52) U.S. Cl. CPC A63F 13/22; A63F 13/24

(57) ABSTRACT

An input device includes a first operation unit having one or a plurality of operation members and a first lower face that functions as an installation face, a second operation unit having one or a plurality of operation members and a second lower face that functions as an installation face, the second operation unit being connected to the first operation unit such that a relative position thereof to the first operation unit is changeable in a direction along the first lower face and the second lower face, and a lock mechanism that switches between a lock state in which the relative position of the first operation unit and the second operation unit is fixed and an unlock state in which a change of the relative position is allowed. The lock mechanism includes a lock operation member and switches between the lock state and the unlock state.

### BACKGROUND

The present disclosure relates to an input device.

In International Publication No. WO 2014/061362 specified below, an input device used for operation of an application of a game or the like is disclosed. The input device includes operation members such as an operation button and an operation stick and is used by a user to input a control signal to the application.

### SUMMARY

Among users, there is such a need as to customize the position of an operation member of an input device to further enhance comfortable operation of a plurality of operation members.

It is a desire for the present disclosure to provide an input device by which an operation can be performed with higher comfortability.

The input device according to the present disclosure may include a first operation unit having one or a plurality of operation members and a first lower face that functions as an installation face, a second operation unit having one or a plurality of operation members and a second lower face that functions as an installation face, the second operation unit being connected to the first operation unit such that a relative position thereof to the first operation unit is changeable in a direction along the first lower face and the second lower face, and a lock mechanism that switches between a lock state in which the relative position of the first operation unit and the second operation unit is fixed and an unlock state in which a change of the relative position is allowed. The lock mechanism may include a lock operation member and may be configured to switch between the lock state and the unlock state in response to an operation of the lock operation member, to maintain the unlock state in a state in which the lock operation member is not operated, and to maintain the lock state in the state in which the lock operation member is not operated. Hence, it becomes possible to perform an operation of the input device more comfortably.

### BRIEF DESCRIPTION OF THE DRAWINGS

FIG. 1 is a perspective view of an input device according to an embodiment of the present disclosure;

FIG. 2 is a top plan view of the input device;

FIG. 3 is a front plan view of the input device;

FIG. 4 is a bottom elevational view of the input device;

FIG. 5 is a top plan view of a second operation unit;

FIG. 6A is a top plan view depicting part of components of a lock mechanism;

FIG. 6B is a top plan view depicting part of the components of the lock mechanism;

FIG. 7 is an exploded perspective view depicting part of the components of the lock mechanism;

FIG. 8 is a cross sectional view of the input device obtained at a cross section taken along line VIII-VIII of FIG. 6B;

FIG. 9A is a top plan view depicting a groove portion of a lock button in an enlarged manner; and

FIG. 9B is a top plan view depicting the groove portion of the lock button in an enlarged manner.

### DETAILED DESCRIPTION OF THE PREFERRED EMBODIMENT

In the following, an input device 1 that is an example of the input device proposed in the present disclosure is described. The input device 1 can be used as an input device for an information processing apparatus (for example, a game apparatus or a video reproduction apparatus) having an execution function of an application (for example, a game application). The input device 1 is capable of communicating with the information processing apparatus in a wired or wireless manner and transmits a signal according to an operation performed for the input device 1 by a user to the information processing apparatus.

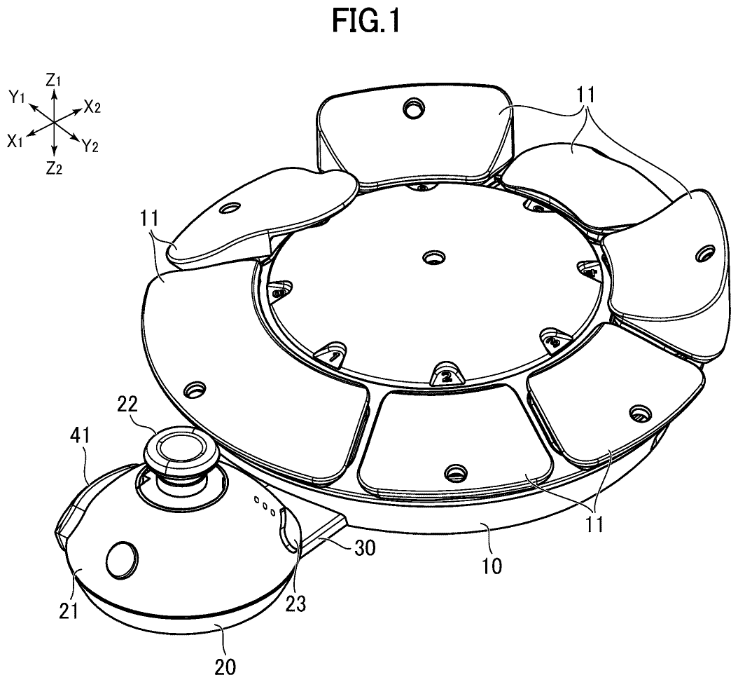

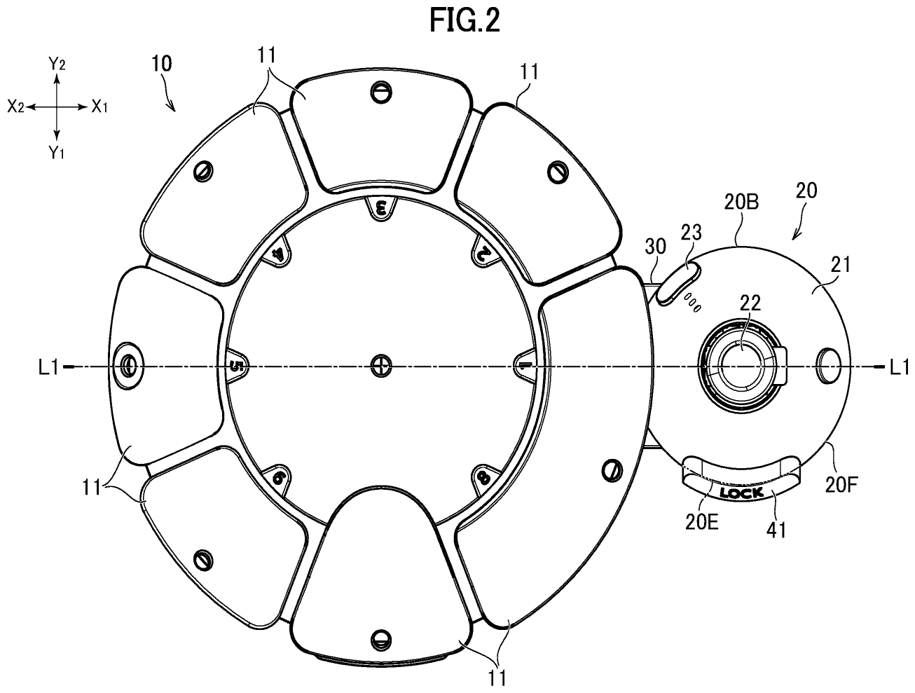

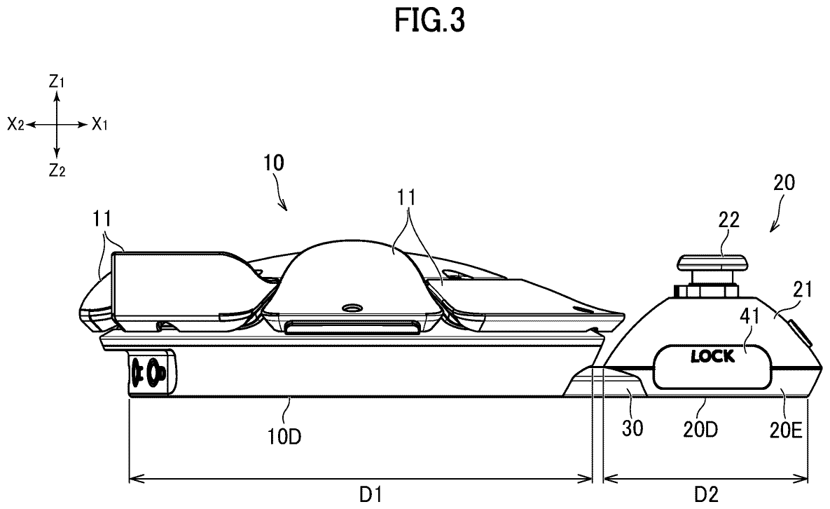

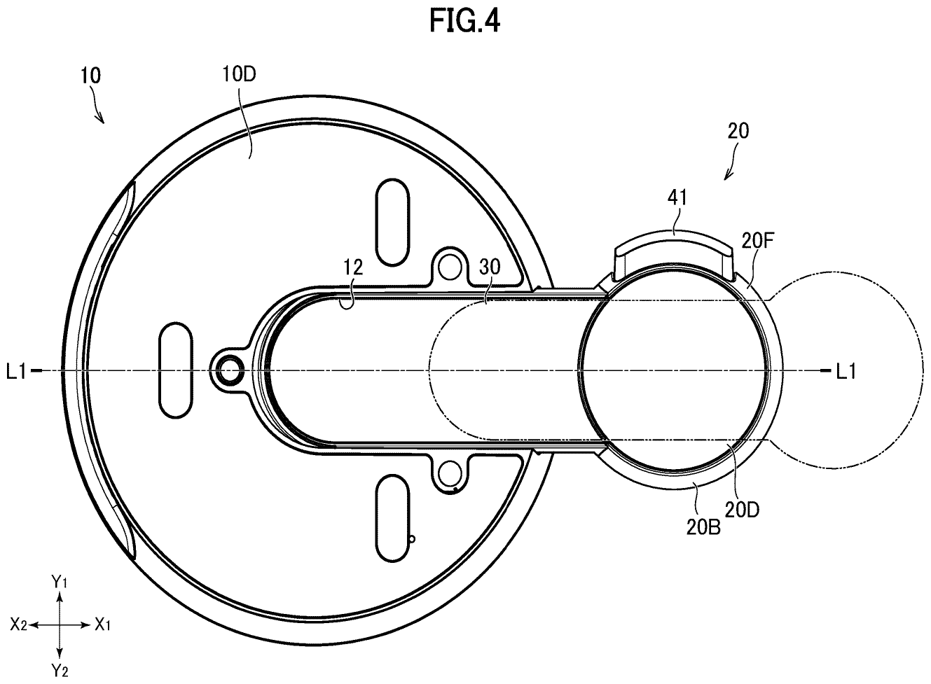

FIG. 1 is a perspective view of the input device 1. FIG. 2 is a top plan view of the input device 1. FIG. 3 is a front elevational view of the input device 1. FIG. 4 is a bottom plan view of the input device 1. Individual components of the input device 1 to be described later may each be formed from a resin such as plastics, a metal, a composite material of them, or the like.

In the following description, an X1 direction and an X2 direction of an X axis (direction in which a first operation unit 10 and a second operation unit 20 to be described later are lined up) depicted in FIG. 1 and so forth are referred to as a rightward direction and a leftward direction, respectively. Further, a Y1 direction and a Y2 direction of a Y axis perpendicular to the X axis are referred to as a forward direction and a rearward direction, respectively. Furthermore, a Z1 direction and a Z2 direction of a Z axis (an extending direction of an operation stick 22 to be described later) perpendicular to the X axis and the Y axis are referred to as an upward direction and a downward direction, respectively. It is to be noted, however, that these directions and arrangement positions are defined in order to explain shapes and relative positional relations of elements (parts, members, and portions) of the input device 1 and do not restrict a posture of the input device 1.

As depicted in FIGS. 1 and 2, the input device 1 may have the first operation unit 10 that is a main body thereof, and the second operation unit 20 connected to the first operation unit 10. The size of the second operation unit 20 may be smaller than the size of the first operation unit 10. In the following description, each of the first operation unit 10 and the second operation unit 20 is sometimes referred to merely as an “operation unit.”

As depicted in FIGS. 1 and 2, a plurality of (in the example depicted in FIG. 1, seven) operation buttons 11 may be arranged on an upper face of the first operation unit 10. It is to be noted that the number of operation buttons 11 to be arranged on the first operation unit 10 may otherwise be one or a plural number other than 7. The first operation unit 10 may have an operation member such as an operation stick or a touch panel in addition to the operation buttons 11 or in place of the operation button 11.

As depicted in FIGS. 1 and 3, the second operation unit 20 may have a dome-shaped cover member 21 swollen in whole in the upward direction, and an operation stick 22. In the top plan view depicted in FIG. 2, the operation stick 22 is arranged at a central portion of the second operation unit 20 and extends passing through a hole formed at a top portion of the cover member 21. It is to be noted that the second operation unit 20 may have an operation member such as an operation button (a button different from a lock button 41 such as a button 23 to be described later) or a touch panel in addition to the operation stick 22 or in place of the second operation unit 20.

The second operation unit 20 may be arranged next to the first operation unit 10 in a direction perpendicular to the upward and downward direction (for example, in the leftward and rightward direction). The first operation unit 10 and the second operation unit 20 may be arranged, for example, on an upper face of a desk, an upper face of an armrest of a chair, an upper face of a femoral area of a user, or the like. As depicted in FIGS. 3 and 4, the first operation unit 10 may have a lower face 10D, and the second operation unit 20 may have a lower face 20D. The lower face 10D and the lower face 20D may be arranged at a same position in the upward and downward direction. The lower face 10D and the lower face 20D of the operation units function as installation surfaces to be installed, for example, on an upper face of a desk. The input device 1 may be an input device of what is generally called stationary type. For example, regarding the first operation unit 10, the lower face 10D that is a face on an opposite side to the upper face on which the plurality of operation buttons 11 are arranged functions as the installation surface.

The second operation unit 20 may be connected to the first operation unit 10. The second operation unit 20 may be able to change its relative position to the first operation unit 10 in a direction along the lower face 10D and the lower face 20D of the operation units. This makes it possible to adjust the relative position of the first operation unit 10 on which the plurality of operation buttons 11 are arranged and the second operation unit 20 on which the operation stick 22 is arranged at a position at which the user can perform an operation comfortably. In the example depicted in the figures, it may be possible to change the distance of the second operation unit 20 from the first operation unit 10 by moving the second operation unit 20, for example, in the leftward and rightward direction (the first direction). Further, the second operation unit 20 may be able to be moved in a circumferential direction around the first operation unit 10.

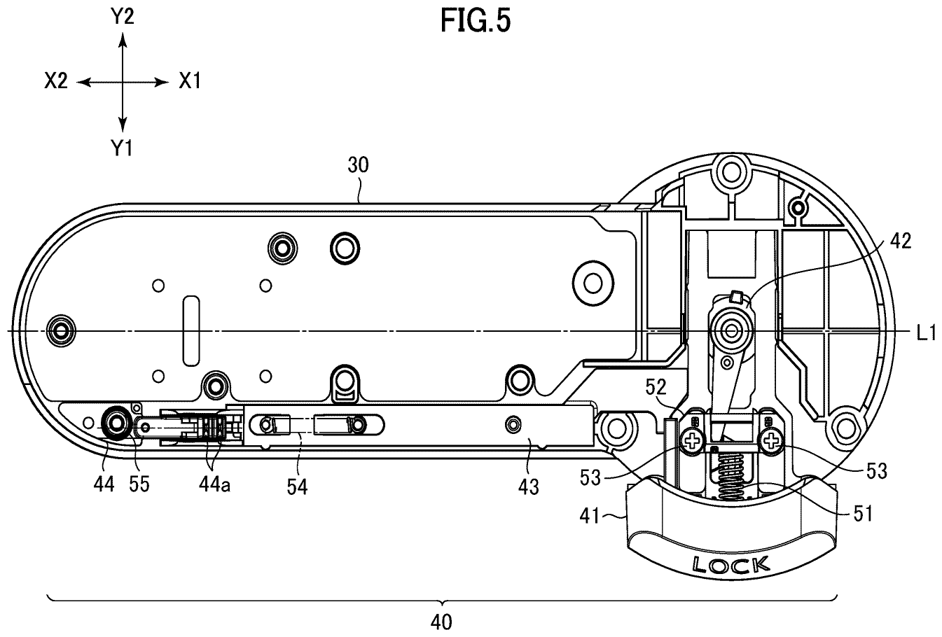

Further, the input device 1 may have a lock mechanism 40 (refer to FIG. 5 and so forth) that performs switching between a lock state in which the lock mechanism 40 fixes the relative position of the first operation unit 10 and the second operation unit 20 and an unlock state in which the lock mechanism 40 permits a change of the relative position of the first operation unit 10 and the second operation unit 20. The lock mechanism 40 may include a lock button 41 (lock operation member) and may perform switching between the lock state and the unlock state in response to an operation of the lock button 41.

In a case where the lock mechanism 40 is switched to the lock state in response to an operation of the lock button 41, it may maintain the lock state in a state in which the lock button 41 is not pressed (a state in which the lock button 41 is not operated). This makes it possible to fix, in a state in which the lock button 41 is not operated, the relative position of the first operation unit 10 and the second operation unit 20 at a position at which the user can perform an operation comfortably. In contrast, in a case where the lock mechanism 40 is switched to the unlock state in response to an operation of the lock button 41, it may maintain the unlock state in the state in which the lock button 41 is not pressed (the state in which the lock button 41 is not operated). This makes it possible for the user to adjust the relative position of the first operation unit 10 and the second operation unit 20 in the state in which the lock button 41 is not pressed. Therefore, a user who has difficulty in moving a finger can implement the unlock state by pressing the lock button 41, for example, with the back of a hand, and thereafter, the user can adjust the relative position of the first operation unit 10 and the second operation unit 20 by pressing the second operation unit with the back of the hand as well.

FIG. 5 is a top plan view of the second operation unit 20. In FIG. 5, there is depicted a state in which, from the second operation unit 20, an upper part including the cover member 21, the operation stick 22, a support structure for the operation stick 22, a circuit board electrically connected to the support structure, and so forth is removed. In the example depicted in FIG. 5, the lock mechanism 40 maintains the unlock state.

The lock button 41 may be arranged on the second operation unit 20. In a case where the size of the second operation unit 20 is smaller than the size of the first operation unit 10, the user tries to move the second operation unit 20 rather than the first operation unit 10. Therefore, by arranging the lock button 41 on the second operation unit 20 the user tries to move, it is possible to make it easy for the user to intuitively grasp the use of the lock button 41 to perform switching between the lock state and the unlock state.

As depicted in FIG. 4, the second operation unit 20 may have fixed thereto a connection portion 30 that extends in the leftward and rightward direction (first direction) and is connected to the first operation unit 10. The connection portion 30 may be relatively movable in the leftward and rightward direction with respect to the first operation unit 10 as indicated by an alternate long and two short dashes line in FIG. 4. The first operation unit 10 may have, on a bottom portion thereof, a recess portion 12 in which the connection portion 30 is fitted. The connection portion 30 may relatively move in its extending direction with respect to the recess portion 12. This makes it possible for the second operation unit 20 to change the distance thereof from the first operation unit 10 in the extending direction of the connection portion 30.

As depicted in FIG. 3, the width D1 of the first operation unit 10 in the leftward and rightward direction (first direction) may be greater than the width D2 of the second operation unit 20 in the leftward and rightward direction. By forming the recess portion 12 having a greater width in the leftward and rightward direction on the first operation unit 10, a size of the recess portion 12 in the leftward and rightward direction can be secured. This makes it possible to secure a movable range of the connection portion 30 and the second operation unit 20 to which the connection portion 30 is fixed.

The lock button 41 can move, for example, in the forward and rearward direction (second direction crossing with the first direction). As depicted in FIGS. 2 and 4, the lock button 41 may be arranged on one side (in the example depicted in FIGS. 2 and 5, on the front side) with respect to a straight line L1 (center line of the connection portion 30 depicted in FIG. 4) extending along the leftward and rightward direction. By arranging the lock button 41 in this manner, the second operation unit 20 can be suppressed from moving with respect to the first operation unit 10 during an operation of the lock button 41 (when the lock button 41 is pressed).

As depicted in FIGS. 2 and 4, the second operation unit 20 may include a front face 20F (first face) and a rear face 20B (second face) directed to the opposite sides to each other across the straight line L1. The lock button 41 may be arranged only on the front face 20F of the second operation unit 20. The lock button 41 may not be arranged on the rear face 20B of the second operation unit 20. By arranging the lock button 41 in this manner, it is possible to facilitate an operation for switching between the lock state and the unlock state, for example, in comparison with that in an alternative case in which an operation member for switching between the lock state and the unlock state is arranged on both the front face 20F and the rear face 20B of the second operation unit 20. For example, the user can press the lock button 41 rearwardly while holding down the rear face 20B of the second operation unit 20 with the back of a hand or the like.

As depicted in FIGS. 2 and 3, the lock button 41 may be arranged along a lower edge 20E of the second operation unit 20 (which is an outer edge of the second operation unit 20 depicted in FIG. 2 and is an outer edge of the lower face 20D of the second operation unit 20 depicted in FIG. 3) on an outer face of the second operation unit 20. By arranging the lock button 41 in this manner, an operation of the lock button 41 can be made easier. For example, the user can press the lock button 41 rearwardly with the back of the hand or the like by placing a hand on an upper face of a desk or the like on which the input device 1 is placed and slidably moving the hand along the upper face.

The lock button 41 can be pressed, for example, rearwardly (to one side in the second direction). As depicted in FIG. 5, the lock mechanism 40 may have a spring 51 (an example of an elastic member) that biases the lock button 41 forwardly (to the other side in the second direction). The spring 51 may be a coil spring and may be attached at one end thereof to the lock button 41 and at the other end thereof to an attachment member 52 fixed to the second operation unit 20 by screws 53 or the like. The user can press the lock button 41 against the elastic force of the spring 51.

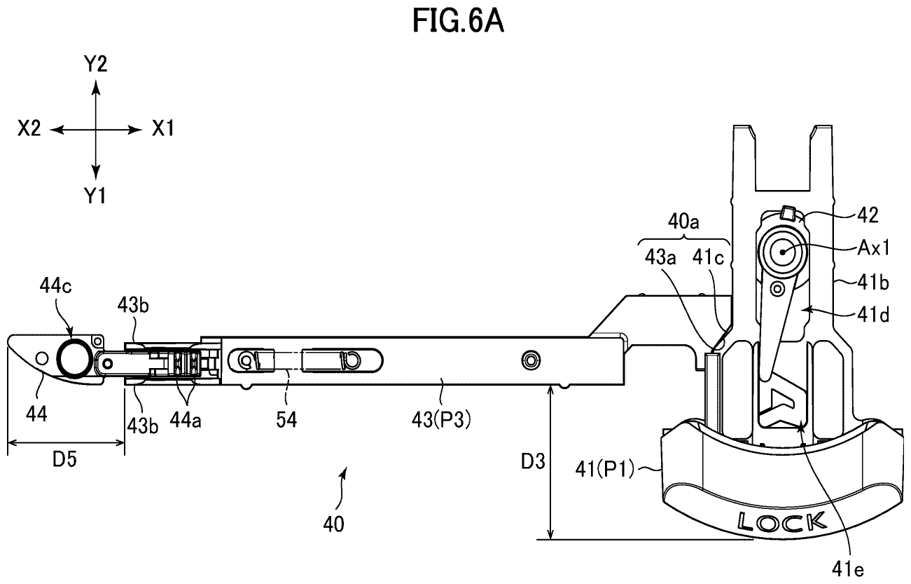

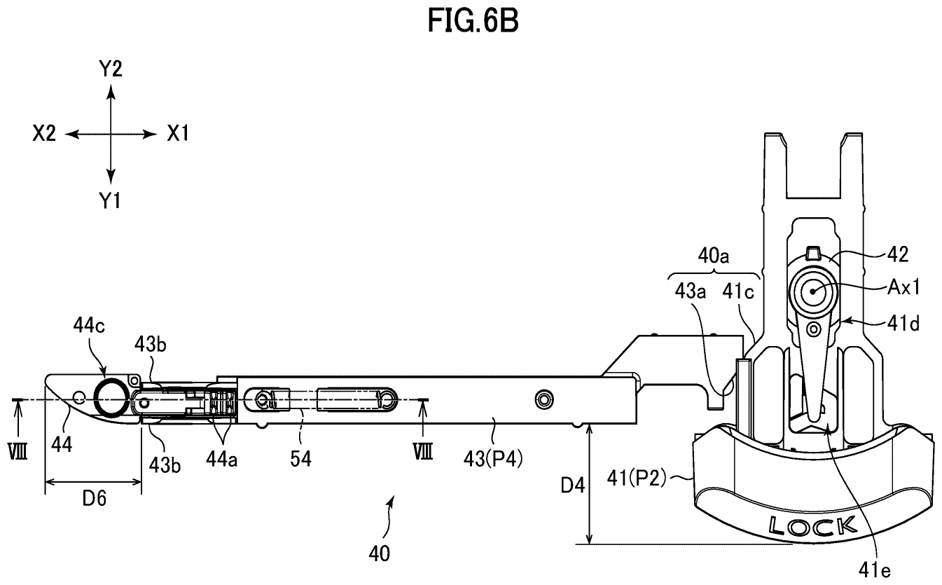

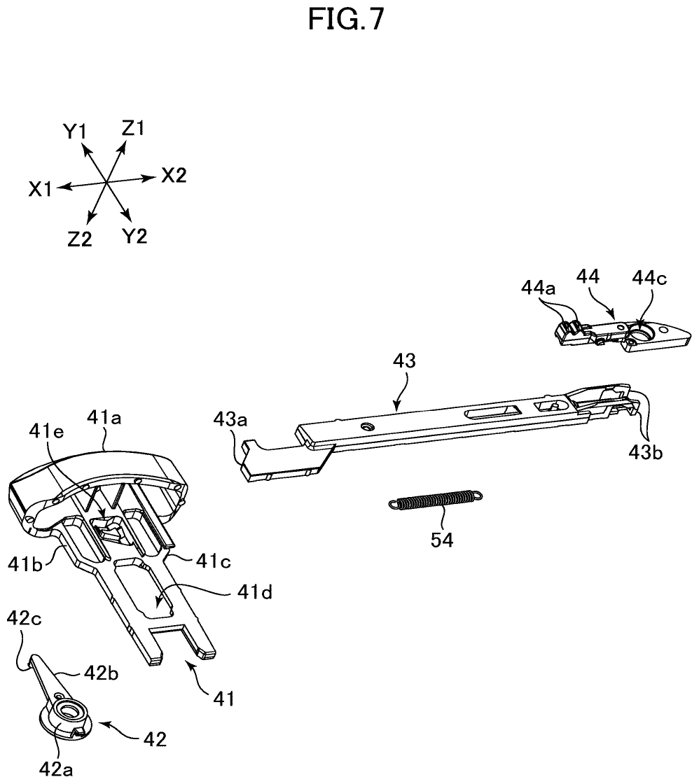

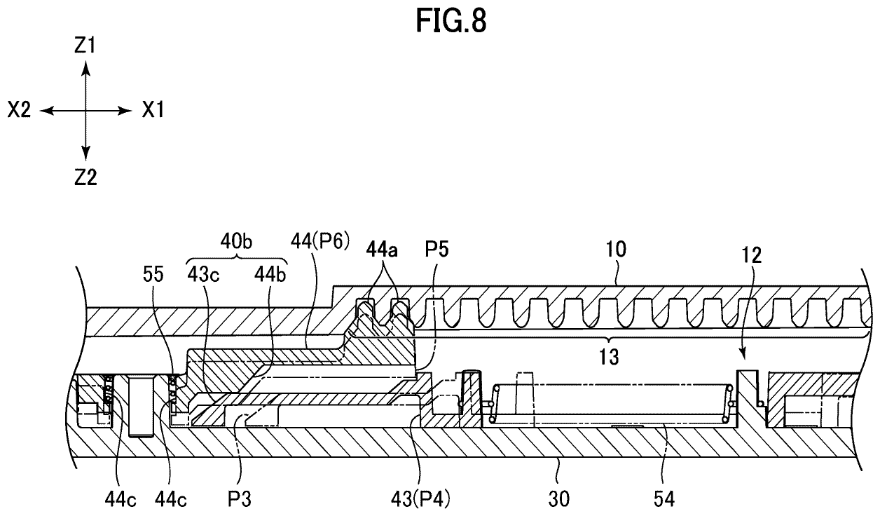

FIGS. 6A and 6B are views of part of components of the lock mechanism 40 extracted from FIG. 5. FIG. 7 is an exploded perspective view depicting components of the lock mechanism 40 depicted in FIGS. 6A and 6B. As depicted in FIG. 7, the lock mechanism 40 may include a latching member 42, a slide member 43, an engaging member 44, and a spring 54 in addition to the lock button 41. As depicted in FIG. 5, the slide member 43 and the engaging member 44 may be provided on the connection portion 30. The engaging member 44 may have a second engaging portion 44a for engaging with a first engaging portion 13 (refer to FIG. 8) formed on the first operation unit 10. The second engaging portion 44a may engage with the first engaging portion 13 to fix the relative position of the connection portion 30 and the first operation unit 10. It is to be noted that, although, in the example depicted in FIG. 7, the number of second engaging portions 44a is two, the number of engaging portions to be provided on the engaging member 44 may be one or a plural number equal to or greater than 3.

As depicted in FIG. 7, the lock button 41 may have a button portion 41a on which an operation face for which the user is to perform a pressing operation is formed, and a plate portion 41b in the form of a flat plate extending rearwardly from the button portion 41a. On the plate portion 41b, an inclined face 41c, a hole portion 41d, and a groove portion 41e to be described later may be formed.

In FIG. 6A, the lock mechanism 40 maintains the unlock state, similarly as in FIG. 5. Meanwhile, in FIG. 6B, the lock mechanism 40 maintains the lock state. In the state depicted in FIG. 6A, the lock button 41 is placed at an unlock position P1 (position forwardly with respect to a lock position P2 depicted in FIG. 6B) at which the lock mechanism 40 maintains the unlock state. Meanwhile, in the state depicted in FIG. 6B, the lock button 41 is placed at the lock position P2 (position rearwardly with respect to the unlock position P1 depicted in FIG. 6A) at which the lock mechanism 40 maintains the lock state. While the lock button 41 moves in the forward and rearward direction, the positions of the slide member 43 and the engaging member 44 in the forward and rearward direction may be invariable. The distance D3 (refer to FIG. 6A) between the front end of the lock button 41 and the slide member 43 in a case where the lock button 41 is placed at the unlock position P1 may be greater than the distance D4 (refer to FIG. 6B) between the front end of the lock button 41 and the slide member 43 in a case where the lock button 41 is placed at the lock position P2. The lock button 41 may be pressed rearwardly from each of the positions depicted in FIGS. 6A and 6B.

FIG. 8 is a cross sectional view of the input device 1 obtained at a cross section taken along line VIII-VIII of FIG. 6B and depicts a cross section of part of the first operation unit 10 and part of the connection portion 30. As depicted in FIG. 8, the first operation unit 10 (more particularly, the recess portion 12 in which the connection portion 30 is fitted) may have the first engaging portion 13 formed thereon. The first engaging portion 13 may be provided on an outer face of the first operation unit 10 on which the recess portion 12 is formed and may be provided continuously along the leftward and rightward direction. The second engaging portion 44a provided on the engaging member 44 may engage with the first engaging portion 13 at any position of the first engaging portion 13 in the leftward and rightward direction. The second engaging portion 44a may be a protruding portion protruding in the upward direction, and the first engaging portion 13 may be a plurality of recess portions which are recessed in the upward direction.

As depicted in FIG. 8, the slide member 43 may move in the leftward and rightward direction (first direction), and the engaging member 44 may move in the upward and downward direction (third direction crossing with the first direction). The slide member 43 may move the engaging member 44 in the upward and downward direction to place the first engaging portion 13 and the second engaging portion 44a into engagement with each other. Further, the slide member 43 may move the engaging member 44 to cancel the engagement between the first engaging portion 13 and the second engaging portion 44a. The engaging member 44 may move between a lock position P6 (a position of the engaging member 44 indicated by a solid line in FIG. 8) at which the second engaging portion 44a engages with the first engaging portion 13 and an unlock position P5 (a position in the downward direction from the lock position P6, or a position of the engaging member 44 indicated by an alternate long and two short dashes line in FIG. 8). While the engaging member 44 moves in the upward and downward direction, the positions of the lock button 41 and the slide member 43 in the upward and downward direction may be invariable.

As depicted in FIG. 8, the lock mechanism 40 may have a spring 55 that biases the engaging member 44 in the downward direction. Further, the engaging member 44 may have a recess portion 44c in which the spring 55 is fitted. The spring 55 may be a coil spring. In a case where the slide member 43 moves from a lock position P4 (position at which the lock mechanism 40 maintains the lock state) to an unlock position P3 (a position at which the lock mechanism 40 maintains the unlock state, or a position in the rightward direction from the lock position P4), the engaging member 44 may move from the lock position P6 (a position of the engaging member 44 indicated by a solid line in FIG. 8) at which the second engaging portion 44a engages with the first engaging portion 13 to the unlock position P5 (a position of the engaging member 44 indicated by an alternate long and two dashes line in FIG. 8) at which the engagement of the second engaging portion 44a with the first engaging portion 13 is cancelled.

As depicted in FIG. 7, the slide member 43 may be a member extending in the leftward and rightward direction (first direction) along the connection portion 30 (refer to FIG. 5) and may have, at a left end portion thereof (right end portion in FIG. 7), two guide walls 43b along the upward and downward direction. The guide walls 43b may be provided in a spaced relation from each other in the forward and rearward direction and may restrict the movement of the engaging member 44 in the forward and rearward direction. This makes it possible to guide the movement of the engaging member 44 in the upward and downward direction.

In the state depicted in FIG. 6A, the slide member 43 is placed at the unlock position P3. Meanwhile, in the state depicted in FIG. 6B, the slide member 43 is placed at the lock position P4. While the slide member 43 relatively moves in the leftward and rightward direction with respect to the second operation unit 20 and the connection portion 30, the positions of the second operation unit 20 and the connection portion 30 of the lock button 41 and the engaging member 44 in the leftward and rightward direction may be invariable. The distance D5 (refer to FIG. 6A) between the left end of the slide member 43 and the left end of the engaging member 44 in a case where the slide member 43 is placed at the unlock position P3 may be greater than the distance D6 (refer to FIG. 6B) between the left end of the slide member 43 and the left end of the engaging member 44 in a case where the slide member 43 is placed at the lock position P4. The slide member 43 may be biased in the rightward direction by the spring 54. The spring 54 may be a coil spring. As depicted in FIG. 8, the spring 54 may be attached at one end thereof to the slide member 43 and fixed at the other end thereof to the second operation unit 20. In a case where the lock button 41 moves from the lock position P2 depicted in FIG. 6B to the unlock position P1 depicted in FIG. 6A, the slide member 43 may move from the lock position P4 to the unlock position P3 as depicted in FIG. 8.

The lock mechanism 40 may have a first conversion mechanism 40a that converts a movement of the lock button 41 in the forward and rearward direction (second direction) into a movement of the slide member 43 in the leftward and rightward direction (first direction). As depicted in FIGS. 6A and 6B, the inclined face 41c directed in the rearward and leftward direction may be formed on an outer edge of the plate portion 41b of the lock button 41, and an inclined face 43a directed in the forward and rightward direction may be formed at a right end portion of the slide member 43. The first conversion mechanism 40a may include the inclined faces 41c and 43a. The inclined face 41c of the lock button 41 abuts against the inclined face 43a of the slide member 43, so that a movement of the lock button 41 in the forward and rearward direction can be converted into a movement of the slide member 43 in the leftward and rightward direction. The slide member 43 positioned at the unlock position P3 depicted in FIG. 6A may be pressed by the lock button 41 to move in the leftward direction to the lock position P4 depicted in FIG. 6B.

Further, the lock mechanism 40 may have a second conversion mechanism 40b that converts a movement of the slide member 43 in the upward and downward direction (the first direction) into a movement of the engaging member 44 in the upward and downward direction (the third direction). As depicted in FIG. 8, an inclined face 43c directed in the upward direction and leftward direction may be formed at a left end portion of the slide member 43, and an inclined face 44b directed in the downward direction and rightward direction may be formed on the engaging member 44. The second conversion mechanism 40b may include the inclined faces 43c and 44b. The inclined face 43c of the slide member 43 abuts against the inclined face 44b of the engaging member 44, so that a movement of the slide member 43 in the leftward and rightward direction can be converted into a movement of the engaging member 44 in the upward and downward direction. As depicted in FIG. 8, the engaging member 44 positioned at the unlock position P5 may be pressed by the slide member 43 to move in the upward direction to the lock position P6 at which the second engaging portion 44a engages with the first engaging portion 13.

The latching member 42 may latch the lock button 41 at the lock position P2 (a position at which the lock mechanism 40 maintains the lock state). Further, the latching member 42 may latch the lock button 41 at the unlock position P1 (a position at which the lock mechanism 40 maintains the unlock state). As depicted in FIG. 7, the latching member 42 may have a tubular portion 42a of a tubular shape extending in the upward and downward direction, an extension portion 42b extending in a direction crossing with the upward and downward direction from the tubular portion 42a, and a protruding portion 42c protruding downwardly from an end portion of the latching member 42. The relative position of the latching member 42 with respect to the second operation unit 20 may be invariable. Further, the tubular portion 42a of the latching member 42 may be attached to the second operation unit 20. As depicted in FIGS. 6A and 6B, the tubular portion 42a may be capable of moving around an axial line Ax1 (an axial line extending in a perpendicular direction of the plane of FIGS. 6A and 6B). The tubular portion 42a may penetrate through the hole portion 41d formed in the plate portion 41b of the lock button 41. The hole portion 41d of the lock button 41 may be formed greater than the tubular portion 42a in the forward and rearward direction. This makes it possible for the lock button 41 to move in the forward and rearward direction with respect to the tubular portion 42a.

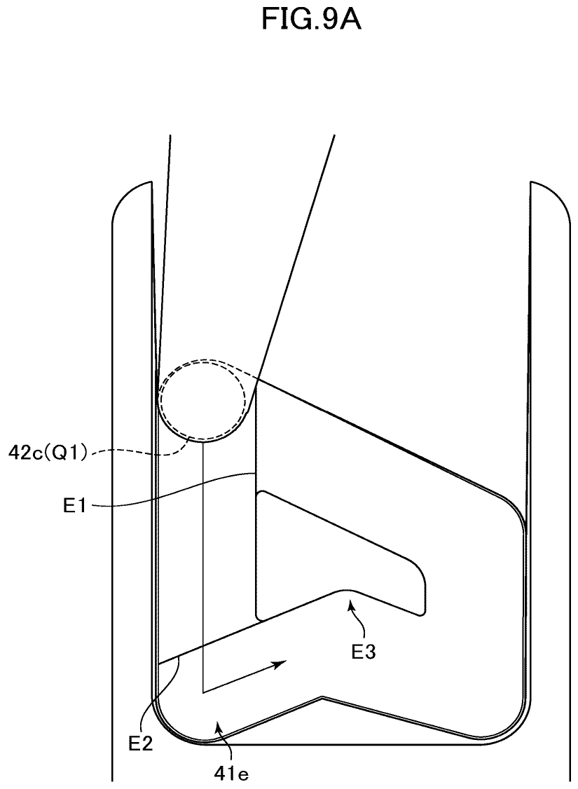

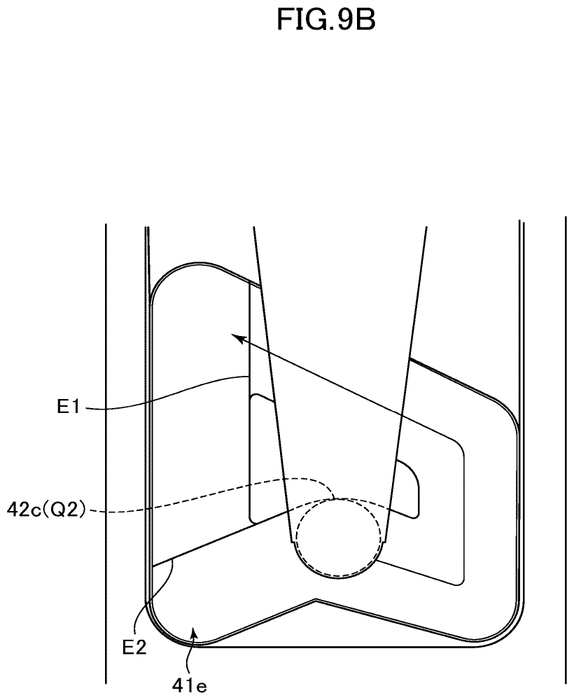

FIG. 9A is an enlarged view of FIG. 6A, and FIG. 9B is an enlarged view of FIG. 6B. FIGS. 9A and 9B depict the groove portion 41e formed in the plate portion 41b of the lock button 41 in an enlarged manner. As depicted in FIGS. 9A and 9B, the groove portion 41e may be in an annular shape. The protruding portion 42c of the latching member 42 may engage with the groove portion 41e and move along the groove portion 41e. In FIGS. 9A and 9B, an arrow mark indicates a movement of the protruding portion 42c in the groove portion 41e. In the groove portion 41e, the protruding portion 42c may be capable of moving between a position Q1 depicted in FIG. 9A and a position Q2 depicted in FIG. 9B. This makes it possible to allow the lock button 41 to be latched at the lock position P2 or allow the lock button 41 to be moved to the unlock position P1 by elastic force of the spring 51 (refer to FIG. 5).

In a case where the protruding portion 42c is positioned at the position Q1 depicted in FIG. 9A, when the lock button 41 is pressed rearwardly, the protruding portion 42c may move forwardly along the groove portion 41e formed in the lock button 41 as indicated by an arrow mark in FIG. 9A. In the example depicted in FIG. 9A, the position Q1 is provided at a corner portion between a rear end portion and a left end portion of the groove portion 41e. Further, although the groove portion 41e is formed also in a diagonal direction of the forward and rightward direction from the position Q1, a step E2 may be formed therebetween. The protruding portion 42c may be prevented from moving in a diagonal direction of the forward and rightward direction by abutting against the step E2 in such a manner as to be guided to advance forwardly. An inclined face inclined upwardly may be formed in front of the position Q1, and the step E2 may be formed at a front end portion of the inclined face. The protruding portion 42c which is moved forwardly as a result of being pressed by the lock button 41 may run on the inclined face and get caught on the step E2.

When the pressure on the lock button 41 is cancelled, then the lock button 41 may be moved forwardly by the elastic force of the spring 51 (refer to FIG. 5). Here, the protruding portion 42c which gets caught on the step E2 may move in the diagonal direction of the rearward and rightward direction along the step E2 as indicated by an arrow mark in FIG. 9A and may be latched by an edge portion E3 being recessed forwardly at a middle portion of the groove portion 41e. This makes it possible for the protruding portion 42c to be latched at the position Q2 depicted in FIG. 9B and to latch the lock button 41 at the lock position P2 depicted in FIG. 6B. In this manner, when the protruding portion 42c moves from the position Q1 depicted in FIG. 9A to the position Q2 depicted in FIG. 9B, switching from the unlock state in which a change of the relative position of the first operation unit 10 and the second operation unit 20 is allowed to the lock state in which the relative position of the first operation unit 10 and the second operation unit 20 is fixed can be performed.

In a case where the protruding portion 42c is positioned at the position Q2 depicted in FIG. 9B, when the lock button 41 is pressed rearwardly, the protruding portion 42c may move in a diagonal direction of the rightward and forward direction along an edge portion E4 on the front side of the groove portion 41e as indicated by an arrow mark in FIG. 9B. If the pressure on the lock button 41 is cancelled, then the lock button 41 may be moved forwardly by the elastic force of the spring 51 (refer to FIG. 5). Then, if the pressure on the lock button 41 is cancelled, the lock button 41 may be moved forwardly by the elastic force of the spring 51 (refer to FIG. 5), and the protruding portion 42c may move rearwardly along the groove portion 41e as indicated by an arrow mark in FIG. 9B and move in a diagonal direction of the rearward and leftward direction along an edge portion E5 on the rear side of the groove portion 41e. Then, the protruding portion 42c may override a step E1 on the inner side of the groove portion 41e and be placed at the position Q1 depicted in FIG. 9A. In this manner, when the protruding portion 42c moves from the position Q2 depicted in FIG. 9B to the position Q1 depicted in FIG. 9A, switching from the lock state in which the relative position of the first operation unit 10 and the second operation unit 20 is fixed to the unlock state in which a change of the relative position of the first operation unit 10 and the second operation unit 20 is a can be performed.

As described above, the input device 1 may have the lock mechanism 40 that performs switching between the lock state in which the relative position of the first operation unit 10 and the second operation unit 20 is fixed and the unlock state in which a change of the relative position of the first operation unit 10 and the second operation unit 20 is allowed. The lock mechanism 40 may include the lock button 41 and may switch between the lock state and the unlock state in response to an operation of the lock button 41. The lock mechanism 40 may maintain the unlock state in a state in which the lock button 41 is not operated and may maintain the lock state in the state in which the lock button 41 is not operated. Consequently, the relative position of the first operation unit 10 and the second operation unit 20 can be adjusted to a position at which the user can perform an operation comfortably. Further, by arranging the lock button 41 at an appropriate position of the second operation unit 20, an operation for switching between the lock state and the unlock state can be performed easily.

It is to be noted that the present invention is not restricted to the embodiment described above. In the embodiment, there has been described an example in which the second engaging portion 44a of the engaging member 44 configuring the lock mechanism 40 moves upwardly to thereby be engaged with the first engaging portion 13 positioned above the second engaging portion 44a in the first operation unit 10. This is not restrictive, and the first engaging portion 13 may otherwise be positioned downwardly, rearwardly, or forwardly of the second engaging portion 44a. Also in this case, since the lock mechanism 40 has the second conversion mechanism 40b that converts a movement of the slide member 43 in the leftward and rightward direction (first direction) into a movement of the engaging member 44 in a direction (third direction) crossing with the leftward and rightward direction, it is possible to place the first engaging portion 13 and the second engaging portion 44a into engagement with each other and cancel the engagement between the first engaging portion 13 and the second engaging portion 44a. Also in this case, the lock mechanism 40 can switch between the lock state in which the relative position of the first operation unit 10 and the second operation unit 20 is fixed and the unlock state in which a change of the relative position of the first operation unit 10 and the second operation unit 20 is allowed.

Further, in the embodiment, there has been described an example in which the second operation unit 20 is arranged in the rightward direction of the first operation unit 10. This is not restrictive, and the second operation unit 20 may be arranged in the leftward direction or the forward direction of the first operation unit 10. The second operation unit 20 may be arranged with respect to the first operation unit 10 as desired by the user. Also in this case, the lock mechanism 40 can adjust the relative position of the first operation unit 10 and the second operation unit 20 to a position at which the user can perform an operation comfortably by maintaining the unlock state in the state in which the lock button 41 is not operated and by maintaining the lock state in the state in which the lock button 41 is not operated.

Further, in the embodiment, there has been described an example in which the lock button 41 is arranged on the second operation unit 20. This is not restrictive, and the lock button 41 may be arranged on the first operation unit 10. In this case, the lock button 41 may move the engaging member 44 on which the second engaging portion 44a is formed through such a member as the slide member 43 or may move the engaging member 44 by directly pressing the engaging member 44. Also in this case, by cancelling the engagement between the first engaging portion 13 and the second engaging portion 44a, it is possible to switch between the lock state in which the relative position of the first operation unit 10 and the second operation unit 20 is fixed and the unlock state in which a change of the relative position of the first operation unit 10 and the second operation unit 20 is allowed.

(1)

As described above, an input device described in the present disclosure may include a first operation unit having one or a plurality of operation members and a first lower face that functions as an installation face, a second operation unit having one or a plurality of operation members and a second lower face that functions as an installation face, the second operation unit being connected to the first operation unit such that a relative position thereof to the first operation unit is changeable in a direction along the first lower face and the second lower face, and a lock mechanism that switches between a lock state in which the relative position of the first operation unit and the second operation unit is fixed and an unlock state in which a change of the relative position is allowed. The lock mechanism may include a lock operation member and may be configured to switch between the lock state and the unlock state in response to an operation of the lock operation member, to maintain the unlock state in a state in which the lock operation member is not operated, and to maintain the lock state in the state in which the lock operation member is not operated. Hence, it becomes possible to perform an operation of the input device more comfortably.

(2)

In the input device according to (1) above, the second operation unit may be capable of changing a distance thereof from the first operation unit by being moved in a first direction. In addition, the lock operation member may be arranged on the second operation unit and may be arranged on one side with respect to a straight line extending along the first direction.

(3)

In the input device according to (2) above, the second operation unit may include a first face and a second face directed to the opposite sides to each other across the straight line extending along the first direction. In addition, the lock operation member may be arranged only on the first face.

(4)

In the input device according to (3) above, the lock operation member may be arranged along a lower edge of the second operation unit on an outer face of the second operation unit.

(5)

In the input device according to any one of (1) to (4) above, the second operation unit may have a size smaller than that of the first operation unit, and the lock operation member may be arranged on the second operation unit.

(6)

In the input device according to any one of (1) to (5) above, the second operation unit may move in a first direction to be able to change a distance thereof from the first operation unit. In addition, the second operation unit may have a connection portion fixed thereto, the connection portion extending in the first direction from the second operation unit and being capable of relatively moving in the first direction with respect to the first operation unit. In addition, the first operation unit may have a recess portion formed thereon in which the connection portion is fitted. In addition, the first operation unit may have a width in the first direction greater than that of the second operation unit in the first direction.

(7)

Moreover, an input device described in the present disclosure may include a first operation unit having one or a plurality of operation members and a lower face that functions as an installation face, a second operation unit having one or a plurality of operation members and a lower face that functions as an installation face, the second operation unit being connected to the first operation unit such that a relative position thereof to the first operation unit is changeable in a direction along the lower face thereof, and a lock mechanism that switches between a lock state in which the relative position of the first operation unit and the second operation unit is fixed and an unlock state in which a change of the relative position is allowed. The lock mechanism may include a lock operation member, and the lock operation member may be arranged along a lower edge of the second operation unit on an outer face of the second operation unit. Hence, it becomes possible to perform an operation of the input device more comfortably.

(8)

In the input device according to any one of (1) to (7) above, the second operation unit may be capable of changing a distance thereof from the first operation unit by moving in a first direction. In addition, the second operation unit may have a connection portion fixed thereto, the connection portion extending in the first direction from the second operation unit and being fitted in the first operation unit such that the connection portion is relatively movable in the first direction with respect to the first operation unit. In addition, the lock mechanism may include an engaging member having a first engaging portion formed on the first operation unit and a second engaging portion provided on the connection portion and configured to engage with the first engaging portion and fix the relative position of the connection portion and the first operation unit.

(9)

In the input device according to (8) above, the lock mechanism may maintain, in the unlock state in which the lock operation member is not operated, the state in which the engagement of the first engaging portion and the second engaging portion is cancelled and besides may maintain, in the lock state in which the lock operation member is not operated, the state in which the first engaging portion and the second engaging portion are engaged with each other.

(10)

In the input device according to (8) or (9) above, the lock operation member may be movable in a second direction crossing with the first direction between a lock position in which the first engaging portion and the second engaging portion are engaged with each other and an unlock position in which the engagement between the first engaging portion and the second engaging portion is cancelled. In addition, the lock mechanism may have a latching member, and the latching member may latch, in the unlock state, the lock operation member at the unlock position and latch, in the lock state, the lock operation member at the lock position.

(11)

In the input device according to any one of (1) or (10) above, the second operation unit may be capable of changing a distance thereof from the first operation unit by moving in a first direction. In addition, the second operation unit may have a connection portion fixed thereto, the connection portion extending in the first direction from the second operation unit and being fitted in the first operation unit such that the connection portion is relatively movable in the first direction with respect to the first operation unit. In addition, the lock mechanism may include the lock operation member provided on the second operation unit, a first engaging portion formed on the first operation unit, an engaging member having a second engaging portion provided on the connection portion and configured to engage with the first engaging portion to fix the relative position of the connection portion and the first operation portion, and a slide member provided on the connection portion and configured to move the engaging member to engage the first engaging portion and the second engaging portion with each other or cancel the engagement between the first engaging portion and the second engaging portion.

(12)

In the input device according to (11) above, the slide member may be capable of moving in the first direction. In addition, the lock operation member may be capable of moving in a second direction crossing with the first direction. In addition, the lock mechanism may have a first conversion mechanism that converts a movement of the lock operation member in the second direction into a movement of the slide member in the first direction.

(13)

In the input device according to (11) or (12) above, the slide member may be capable of moving in the first direction. In addition, the engaging member may be capable of moving in a third direction crossing with the first direction. In addition, the lock mechanism may have a second conversion mechanism that converts a movement of the slide member in the first direction into a movement of the engaging member in the third direction.

(14)

In the input device according to any one of (1) to (13) above, the second operation unit may be capable of changing a distance thereof from the first operation unit by being moved in a first direction. In addition, the lock operation member may be capable of moving in a second direction crossing with the first direction. In addition, the lock mechanism may have an elastic member that biases the lock operation member to one side in the second direction, and a latching member positioned on the other side in the second direction from the unlock position at which the lock mechanism maintains the unlock state and besides latching the lock operation member at the lock position at which the lock mechanism maintains the lock state.

It should be understood by those skilled in the art that various modifications, combinations, sub-combinations and alterations may occur depending on design requirements and other factors insofar as they are within the scope of the appended claims or the equivalents thereof.

What is claimed is:

1. An input device comprising:
a first operation unit having one or a plurality of operation members and a first lower face that functions as an installation face;
a second operation unit having one or a plurality of operation members and a second lower face that functions as an installation face, the second operation unit being connected to the first operation unit such that a relative position thereof to the first operation unit is changeable in a direction along the first lower face and the second lower face; and
a lock mechanism that switches between a lock state in which the relative position of the first operation unit and the second operation unit is fixed and an unlock state in which a change of the relative position is allowed,
wherein the lock mechanism includes a lock operation member and is configured to switch between the lock state and the unlock state in response to an operation of the lock operation member, to maintain the unlock state in a state in which the lock operation member is not operated, and to maintain the lock state in the state in which the lock operation member is not operated.

2. The input device according to claim 1,
wherein the second operation unit is capable of changing a distance thereof from the first operation unit by being moved in a first direction, and
the lock operation member is arranged on the second operation unit and is arranged on one side with respect to a straight line extending along the first direction.

3. The input device according to claim 2,
wherein the second operation unit includes a first face and a second face directed to the opposite sides to each other across the straight line extending along the first direction, and
the lock operation member is arranged only on the first face.

4. The input device according to claim 3,
wherein the lock operation member is arranged along a lower edge of the second operation unit on an outer face of the second operation unit.

5. The input device according to claim 1,
wherein the second operation unit has a size smaller than that of the first operation unit, and
the lock operation member is arranged on the second operation unit.

6. The input device according to claim 1,
wherein the second operation unit moves in a first direction to be able to change a distance thereof from the first operation unit,
the second operation unit has a connection portion fixed thereto, the connection portion extending in the first direction from the second operation unit and being capable of relatively moving in the first direction with respect to the first operation unit,
the first operation unit has a recess portion formed thereon in which the connection portion is fitted, and
the first operation unit has a width in the first direction greater than that of the second operation unit in the first direction.

7. An input device comprising:
a first operation unit having one or a plurality of operation members and a lower face that functions as an installation face;
a second operation unit having one or a plurality of operation members and a lower face that functions as an installation face, the second operation unit being connected to the first operation unit such that a relative position thereof to the first operation unit is changeable in a direction along the lower face thereof; and
a lock mechanism that switches between a lock state in which the relative position of the first operation unit and the second operation unit is fixed and an unlock state in which a change of the relative position is allowed,
wherein the lock mechanism includes a lock operation member, and
the lock operation member is arranged along a lower edge of the second operation unit on an outer face of the second operation unit.

8. The input device according to claim 1,
wherein the second operation unit is capable of changing a distance thereof from the first operation unit by moving in a first direction,
the second operation unit has a connection portion fixed thereto, the connection portion extending in the first direction from the second operation unit and being fitted in the first operation unit such that the connection portion is relatively movable in the first direction with respect to the first operation unit, and
the lock mechanism includes an engaging member having a first engaging portion formed on the first operation unit and a second engaging portion provided on the connection portion and configured to engage with the first engaging portion and fix the relative position of the connection portion and the first operation unit.

9. The input device according to claim 8,
wherein the lock mechanism maintains, in the unlock state in which the lock operation member is not operated, the state in which the engagement of the first engaging portion and the second engaging portion is cancelled and besides maintains, in the lock state in which the lock operation member is not operated, the state in which the first engaging portion and the second engaging portion are engaged with each other.

10. The input device according to claim 8,
wherein the lock operation member is movable in a second direction crossing with the first direction between a lock position in which the first engaging portion and the second engaging portion are engaged with each other and an unlock position in which the engagement between the first engaging portion and the second engaging portion is cancelled, and
the lock mechanism has a latching member, and the latching member latches, in the unlock state, the lock operation member at the unlock position and latches, in the lock state, the lock operation member at the lock position.

11. The input device according to claim 1,
wherein the second operation unit is capable of changing a distance thereof from the first operation unit by moving in a first direction,
the second operation unit has a connection portion fixed thereto, the connection portion extending in the first direction from the second operation unit and being fitted in the first operation unit such that the connection portion is relatively movable in the first direction with respect to the first operation unit, and
the lock mechanism includes
the lock operation member provided on the second operation unit,
a first engaging portion formed on the first operation unit,
an engaging member having a second engaging portion provided on the connection portion and configured to engage with the first engaging portion to fix the relative position of the connection portion and the first operation portion, and
a slide member provided on the connection portion and configured to move the engaging member to engage the first engaging portion and the second engaging portion with each other or cancel the engagement between the first engaging portion and the second engaging portion.

12. The input device according to claim 11,
wherein the slide member is capable of moving in the first direction,
the lock operation member is capable of moving in a second direction crossing with the first direction, and
the lock mechanism has a first conversion mechanism that converts a movement of the lock operation member in the second direction into a movement of the slide member in the first direction.

13. The input device according to claim 11,
wherein the slide member is capable of moving in the first direction,
the engaging member is capable of moving in a third direction crossing with the first direction, and
the lock mechanism has a second conversion mechanism that converts a movement of the slide member in the first direction into a movement of the engaging member in the third direction.

14. The input device according to claim 1,
wherein the second operation unit is capable of changing a distance thereof from the first operation unit by being moved in a first direction,
the lock operation member is capable of moving in a second direction crossing with the first direction, and
the lock mechanism has
an elastic member that biases the lock operation member to one side in the second direction, and
a latching member positioned on the other side in the second direction from an unlock position at which the lock mechanism maintains the unlock state and besides latching the lock operation member at the lock position at which the lock mechanism maintains the lock state.
